(19) United States
(12) Patent Application Publication
(10) Pub. No.: US 2003/0149872 A1
(43) Pub. Date: Aug. 7, 2003

(54) Digital certificate verification

(76) Inventors: Keith Alexander Harrison, Woodcroft Chepstow (GB); Marco Casassa Mont, Bristol (GB)

Correspondence Address: HEWLETT-PACKARD COMPANY, Intellectual Property Administration, P.O. Box 272400, Fort Collins, CO, 80527-2400, US

(21) Appl. No.: 10/298,735

(22) Filed: Nov. 18, 2002

(30) Foreign Application Priority Data
Nov. 20, 2001 (GB) 0127740.9

(51) Int. Cl. H04L 9/00

(52) U.S. Cl. 713/155

(57) ABSTRACT

A method of certifying by a certification authority that two or more first digitally signed certificates or identities are held by the same authorised signatory, the method comprising the steps of determining that said two or more identities or digitally signed certificates refer to the same authorised signatory, creating a digital verification certificate including data relating to said two or more identities or first digitally signed certificates and data representative of evidence or facts used to determine that said two or more identities or digitally signed certificates relate to the same authorised signatory, applying a digital signature of the certification authority to said verification certificate, and linking or otherwise associating said verification certificate to said two or more identities or first digitally signed certificates. Thus, the certification authority is arranged to provide an interim digital certificate linking two digital certificates listing two different subject identities but relating to the same authorised digital signatory. Also described is a data structure of such a verification certificate.

### FIELD OF THE INVENTION

This invention relates to digital signature verification and, more particularly, to an improved method and apparatus for verifying the identity of the originator of a digital signature.

### BACKGROUND OF THE INVENTION

Paper documents are the traditional form of communications and agreements between commercial and other transactions. Financial and real-estate transactions, for example, are protected by paper-based controls. Signatures and safety paper (such as pre-printed cheques) facilitate detection of unauthorised alterations of the information of commercial transactions. Important documents may also be provided with third party controls, by witnessing of signatures and by the seal and acknowledgement of a Notary Public, for example.

In this traditional paper-based environment, there are many types of document which can be used by a person to prove their identity as required. For example, a passport or the like. In the case of such paper-based forms of identification, there is usually a checkable chain of information to prove that, for example, that a person claiming to have been the signatory of a document 20 years is in fact that person.

As an example, when a passport expires after 10 years, it must be renewed. In order to renew the passport, the old passport is provided to the passport issuing authority together with an application for issue of a new passport to the same person, so that the passport authority is provided with a “chain” of information which proves that the identity of the person applying for the new passport is in fact the same as the identity of the person who was issued with the original passport. If the original passport is not available, the applicant is required to obtain third party verification of their identity by a trusted member of society, such as a member of the clergy, a doctor or a solicitor.

Methods of commerce, however, have changed dramatically in recent years and continue to evolve rapidly. This is particularly evident in the replacement of paper-based communications with electronic communications. However, standard electronic communications over open systems do not have the same ability as paper-based communications to provide authentication, privacy and integrity of communicated information. For the purposes of this specification, “authentication” means the verification of the identity of the signatory of a document, “privacy” means the protection of the information in a document from unauthorised disclosure, and “integrity” means the ability to detect any alteration of the contents of a document. Hence the creation of digital signature technology.

A digital signature is used to “sign” digital documents, and operates by the attachment thereof to digital documents originating from (or authorised by) the authorised signatory. Digital signatures can be verified electronically, and typically use what is known in the art as Public Key Infrastructure (PKI).

PKI employs an algorithm using two different but mathematically related “keys”, one for creating a digital signature (or transforming data into a seemingly unintelligible form), and another key for verifying a digital signature (or returning the message to its original form). The complementary keys of a PKI for digital signatures are termed the private key, which is known only to the signer and used to create the digital signature, and the public key, which is often more widely known and used by another party to verify the digital signature.

In order to provide some form of certainty to others that an authorised signatory does in fact correspond to the identity of a particular person, one or more trusted third parties are used to associate an identified signer with a specific public key. Such a trusted third party is often termed a “certification authority”. To associate a key pair with a prospective signer, a certification authority (such as a bank, post office, commercial body, etc.) issues a certificate, which is an electronic record listing a public key as the “subject” of the certificate and confirming that the prospective signer identified in the certificate holds the private key. There are several proposed formats and specifications for this type of certificate, and one of the more widely known digital certificate specifications is termed “X509”.

In order to maintain the security and integrity required by such digital certificates, they are generally only valid for one year from the date of issue and, as such, must be renewed annually. Thus, a single person may have been issued several digital certificates over a period of a number of years, many of which may have been issued by different certification authorities. There are many circumstances, for example, in the case of documents which have been digitally signed and stored for a relatively long period of time, such as in a digital document storage system, in which it may be necessary to verify that a digital signatory claiming to have a particular identity now is in fact the same person claiming to have that identity 10 years earlier. This is analogous to the issues outlined above with regard to the paper-based identification methods, but there is currently no mechanism provided in the art for solving this problem and achieving the required authentication, and it is this issue to which the present invention addresses itself.

### SUMMARY OF THE INVENTION

Thus, in accordance with a first aspect of the present invention, there is provided a method of certifying by a certification authority that two or more first digital certificates or identities are held by or relate to the same authorised digital signatory, the method comprising the steps of determining that said two or more identities or digital certificates refer to the same authorised digital signatory, creating a digital verification certificate including data relating to said two or more identities or first digital certificates and data representative of evidence or facts used to determine that said two or more identities or digitally signed certificates relate to the same authorised signatory, applying a digital signature of the certification authority to said verification certificate, and linking or otherwise associating said verification certificate to said two or more identities or first digital certificates.

Also in accordance with the first aspect of the present invention, there is provided a digital verification certificate for use by a certification authority in certifying that two or more identities or first digital certificates are held by or relate to the same authorised digital signatory, said digital verification certificate including data relating to said two or more identities or first digital certificates, data representative of evidence or facts used to determine that said two or more digital certificates or identities relate to the same authorised digital signatory, and a digital signature of the certification authority, said digital verification certificate being linked to or otherwise associated with said two or more first digital certificates or identities.

Thus, the first aspect of the present invention is concerned with the issue (by a trusted certification authority) of one or more intermediate digital verification certificates linking two or more digital certificates or identities held by the same authorised digital signatories to confirm that this is the case.

In accordance with a second aspect of the present invention, there is provided apparatus for tracking the identities of a plurality of authorised digital signatories, the apparatus comprising storage means for storing data relating to said plurality of authorised digital signatories and their respective identities, means for recording a change of identity an authorised digital signatory and storing said change of identity in said storage means, means for storing data relating to evidence provided of said change of identity, and means for issuing a digital verification certificate or other information verifying said change of identity, upon request or otherwise.

It will be appreciated that the apparatus of the second aspect of the present invention may be used to provide a tracking service for use by anyone who wishes to verify the identity of an authorised digital signatory. Thus, also in accordance with the second aspect of the present invention, there is provided a method of verifying the claimed identity of an authorised digital signatory of a digital certificate or digitally signed digital document, the method comprising the steps of storing data relating to a plurality of authorised digital signatories and their respective identities, verifying and recording a change of identity of an authorised digital signatory in the event that the respective identity changes, receiving an enquiry from a third party relating to the identity of a specified authorised digital signatory, and issuing a digital certificate or other information verifying the currently recorded identity of said specified authorised digital signatory.

### BRIEF DESCRIPTION OF THE DRAWINGS

An embodiment of the present invention will now be described by way of example only and with reference to the accompanying drawings, in which:

FIG. 1 is a schematic diagram illustrating the data structure of a digital certificate according to the prior art; and

FIG. 2 is a schematic diagram illustrating the data structure of a verification certificate for use in an exemplary embodiment of the present invention.

### DETAILED DESCRIPTION OF THE INVENTION

The basic theory behind digital signatures and digital certificates will now be given to aid in the understanding of the present invention.

Digital signatures are created and verified by cryptography, the branch of applied mathematics that concerns itself with transforming messages into seemingly unintelligible forms and back again. Digital signatures use what is known as the Public Key Infrastructure (PKI) which employs an algorithm using two different but mathematically related “keys”, one for creating a digital signature (or transforming data into a seemingly unintelligible form), and another key for verifying a digital signature (or returning the message to its original form).

The complementary keys of a PKI for digital signatures are termed the private key, which is known only to the signer and used to create the digital signature, and the public key, which is often more widely known and used by another party to verify the digital signature. Although the keys of the pair are mathematically related, if the PKI system has been designed and implemented securely, it should be computationally infeasible to derive the private key from knowledge of the public key.

Another fundamental process termed a “hash function” is used in both creating and verifying a digital signature. A hash function is an algorithm which creates a digital representation of a piece of data in the form of a “hash value” of a standard length which is usually much smaller than the data but nevertheless substantially unique to it. Any change to the data invariably produces a different hash value when the same hash function is used. In the case of a secure hash function, it should be computationally infeasible to derive the original message from knowledge of its hash function. Hash functions therefore enable the software for creating digital signatures to operate on smaller and predictable amounts of data, while still providing a robust evidentiary correlation to the original data content, thereby efficiently providing assurance that there has been no modification of the message since it was digitally signed.

Typically, a digital signature (a digitally signed hash value of a piece of data) is attached to the data and stored (or transmitted) with the data, or it may be stored (or transmitted) as a separate data element provided it maintains a reliable association with the original data. Verification of a digital signature is accomplished by computing a new hash result of the original data by means of the same hash function used to create the digital signature. Then, using the public key and the new hash value, the verifier checks a) whether the digital signature was created using the corresponding private key, and b) whether the newly computed hash value matches the original hash value which was transformed into the digital signature during the signing process.

To verify a digital signature, the verifier must have access to the signer's public key and have assurance that it correspond to the signer's private key. However, a private and public key pair has no intrinsic association with any person; it is simply a pair of numbers. In order to deal with this issue, one or more trusted third parties are used to associate an identified signer with a specific public key. Such a trusted third party is usually termed a “certification authority”.

In order to associate a key pair with a prospective signer, a certification authority issues a certificate comprising an electronic record which lists a public key as the ‘subject’ of the certificate and confirms that the prospective signer identified in the certificate holds the private key.

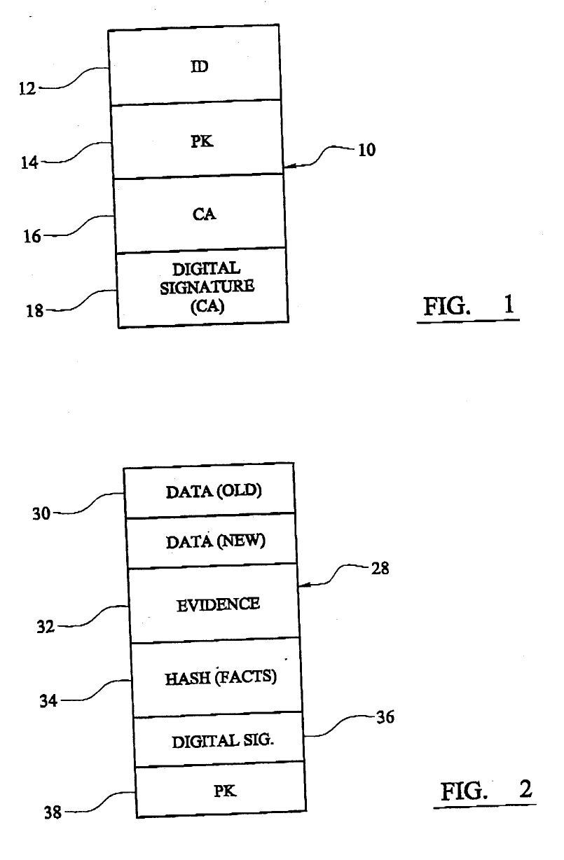

In order to assure both data and identity authenticity of the certificate, the certification authority digitally signs it. Thus, referring to FIG. 1 of the drawings, the data structure of a typical digital certificate 10 includes data 12 identifying the prospective signer, their associated public key 14, data 16 identifying the certification authority issuing the certificate 10 and the digital signature 18 of the certification authority. A prospective signer may then distribute his digital certificate to many different contacts, etc. as required.

As explained above, digital certificates necessarily have a limited operational period, which is currently generally one year from the date of issue, and a single prospective signer may have a series of digital certificates dating back over many years, some or all of which may have been issued by different certification authorities. This introduces the problem of verifying that the identity of a prospective signer listed on a 10-year old digital certificate is the same as that of the prospective signer listed on a current digital certificate.

The present invention provides a method and system for verifying a “chain” of digital certificates for use by a verifying party if it is required to establish the accuracy and honesty of a declared such chain by a prospective signer.

Thus, a tracking agency may be provided, which “tracks” or confirms the integrity of a chain of two or more digital certificates and issues its own verification certificate which a holder of a set of digital certificates can attach to the set and distribute together with that set, as required, for use by anyone who wishes to verify that the set of digital certificates belongs to the claimed signatory. Such a verification certificate could include a wide range of information relating to its subject and would be digitally signed by the tracking agency.

Thus, referring to FIG. 2 of the drawings, an exemplary data structure for a verification certificate 28 is illustrated which includes factual data 30 relating to an “old” digital certificate and a “new” digital certificate, data 32 relating to the evidence used or relied upon to confirm the association between the two certificates, a hash value 34 of the facts, and the tracking agency's digital signature 36 and its public key 38 for use in decrypting and verifying the digital signature 36.

In one embodiment of the present invention, a verification certificate such as the one described above would be issued each time a new digital certificate is issued to a subject authorised signatory, and attached or otherwise linked to the old and new certificates. Alternatively, an authorised signatory may only apply for the issue of a verification certificate when there has been some form of change, for example, a change of the signatory's name or the identity of the certification authority issuing the digital certificate. The verification certificate may also be useful in verifying the signatory's identity when there has been a period of a year or more in which an authorised signatory has not renewed their digital certificate.

There may be circumstances in which the tracking agency would not actually issue a verification certificate in the case of an identity or other change. It may simply record the change and provide a long term service, which may be electronically accessible, to enable users to verify the identity of a signatory having a series of digital certificates, and also to provide such signatories with a single body or authority to inform in the case of a change of identity or other data.

Thus, in summary, an identity tracking agency might be used to issue an identity change certificate upon request by a signatory, which could then be used to provide a long-term electronic service to match the original identities of signatories, whilst giving users a central repository for informing users of changes in their digital certificates. Such an identity change certificate might contain a range of information and would be digitally signed by the identity tracker agency. It may include the user's old and new names, the reason for the change (e.g. marriage), limitations on the trust to be placed in the identity verification (e.g. based on the fact that the same e-mail address applies or the same certification authority has issued both digital certificates to the same person but using different names), and a digital signature.

An existing certification authority could act as an identity tracking agency and issue an identity change or verification certificate each time a new digital certificate is issued to a party. Alternatively, they may issue such a certificate when a party switches to that certification authority from another authority, following some for of investigation or verification of their claimed identity.

Other agencies may operate as identity tracking agencies, and they may investigate name changes (e.g. linking names to marriage certificates) or linking gaps in identity. Equally, such services may issue an identity change certificate to, for example, a person whose identity is the same but with a warning that the name of the company issuing the digital certificate has changed.

A tracking service such as the ones described above may offer an alternative statement that two identities refer to the same person. In the US, in particular, is becoming a popular concept where a user has a digital certificate including a pseudo name rather than their real name. If they need to link their pseudo name to their real name, a verification certificate issued by a tracking agency can be used to provide such a link, as required. In this case, the evidence provided to the tracking agency for the purposes of verifying the truth of the claimed identity link, may be required to kept confidential.

An electronic service, such as a long-term digital document storage service, may implement a protocol whereby when an unknown digital certificate is received, it would ask its owner for a previous identity trail. In the case where there has been no change of name, dates may be requested. However, in general, the service may simply request further information (such as the date on which they last used the service). In any event, the service can match the given names and/or other given information with their customer database and trace back through identity certificates issued by a tracking agency to find a match.

Alternatively, a service might provide a (possibly) on-line check providing a chain of all known names from the current name and negotiating with the service over which chain is appropriate.

Of course, once a service has found a match, it may wish to check whether it believes and trusts the given links. The evidence provided in the data structure described above with reference to FIG. 2 can enable a user to determine whether the claimed identity links are sufficiently strong for their purposes. There may also be some specified limitations on trust, such as changed organisation or weaker certification authority policies. If required, the user can update their customer records with the latest user verification or identity change certificate.

It will be appreciated that, as a general rule, it will be the user who wishes to provide proof of their identity, upon whom the burden of proof of identity will tend to lie.

In the foregoing specification, the invention has been described with reference to specific exemplary embodiments thereof. It will, however, be apparent to a person skilled in the art that various modifications and changes may be made thereto without departing from the broader spirit and scope of the invention as set forth in the appended claims. Accordingly, the specification and drawings are to be regarded in an illustrative, rather than a restrictive, sense.

1. A method of certifying by a certification authority that two or more first digital certificates or identities are held by or relate to the same authorised digital signatory, the method comprising the steps of determining that said two or more identities or digital certificates refer to the same authorised digital signatory, creating a digital verification certificate including data relating to said two or more identities or first digital certificates and data representative of evidence or facts used to determine that said two or more identities or digitally signed certificates relate to the same authorised signatory, applying a digital signature of the certification authority to said verification certificate, and linking or otherwise associating said verification certificate to said two or more identities or first digital certificates.

2. A method according to claim 1, wherein said digitally signed certificates are signed by encryption using a private key, and may be decrypted using a related public key.

3. A method according to claim 2, wherein said verification certificate lists a public key as the “subject” thereof and includes data confirming that the respective authorised digital signatory (holding said two or more first digital certificates or to which said two or more identities relate) identified therein holds the associated private key.

4. A method according to claim 1, wherein said verification certificate is issued in response to a request by a respective authorised digital signatory.

5. A method according to claim 1, wherein said verification certificate is issued in response to a request from a third party.

6. A method according to claim 1, wherein said verification certificate is digitally signed by the certification authority.

7. A method according to claim 1, wherein said digital verification certificate includes one or more of factual data relating to an “old” digital certificate or identity and a “new” digital certificate or identity, data relating to evidence or facts used to determine or verify that two digital certificates or identities relate to the same authorised digital signatory, and an encrypted code representative of said factual data and/or said evidence.

8. A method according to claim 7, wherein said encrypted code is created by applying a hash function to said factual and/or evidential data to produce a hash value thereof.

9. A digital verification certificate for use by a certification authority in certifying that two or more identities or first digitally signed certificates are held by the same authorised signatory, said digital verification certificate including data relating to said two or more identities or first digitally signed certificates, data representative of evidence or facts used to determine that said two or more digitally signed certificates or identities relate to the same authorised digital signatory, and a digital signature of the certification authority, said digital verification certificate being linked to or otherwise associated with said two or more first digital certificates or identities.

10. A digital verification certificate according to claim 9, including one or more of factual data relating to an “old” digital certificate or identity and a “new” digital certificate or identity, data relating to evidence or facts used to determine or verify that two digital certificates or identities relate to the same authorised digital signatory, and an encrypted code representative of said factual data and/or said evidence.

11. Apparatus for tracking the identities of a plurality of authorised digital signatories, the apparatus being configured to store data relating to said plurality of authorised digital signatories and their respective identities, record a change of identity of an authorised digital signatory and store said change of identity in said storage means, the apparatus including a system for storing data relating to evidence provided of said change of identity and for issuing a digital verification certificate or other information verifying said change of identity, upon request or otherwise.

12. A method of verifying the claimed identity of an authorised digital signatory of a digital certificate or digitally signed digital document, the method comprising the steps of storing data relating to a plurality of authorised digital signatories and their respective identities, verifying and recording a change of identity of an authorised digital signatory in the event that the respective identity changes, receiving an enquiry from a third party relating to the identity of a specified authorised digital signatory, and issuing a digital certificate or other information verifying the currently recorded identity of said specified authorised digital signatory.

13. A method of certifying by a certification authority that two or more first digital certificates or identities are held by or relate to the same authorised digital signatory, the method comprising the steps of determining that said two or more identities or digital certificates refer to the same authorised digital signatory, creating a digital verification certificate including data relating to said two or more identities or first digital certificates and data representative of evidence or facts used to determine that said two or more identities or digitally signed certificates relate to the same authorised signatory, applying a digital signature of the certification authority to said verification certificate, and linking or otherwise associating said verification certificate to said two or more identities or first digital certificates, wherein said digital verification certificate includes one or more of factual data relating to an “old” digital certificate or identity and a “new” digital certificate or identity, data relating to evidence or facts used to determine or verify that two digital certificates or identities relate to the same authorised digital signatory, and an encrypted code representative of said factual data and/or said evidence.

14. A digital verification certificate for use by a certification authority in certifying that two or more identities or first digitally signed certificates are held by the same authorised signatory, said digital verification certificate including data relating to said two or more identities or first digitally signed certificates, data representative of evidence or facts used to determine that said two or more digitally signed certificates or identities relate to the same authorised digital signatory, and a digital signature of the certification authority, said digital verification certificate being linked to or otherwise associated with said two or more first digital certificates or identities, said digital verification certificate including one or more of fatal data relating to an “old” digital certificate and a “new” digital certificate or identity, data relating to evidence or facts used to determine or verify that two digital certificates or identities relate to the same authorised digital signatory, and an encrypted code representative of said factual data and/or said evidence.
